(19) United States
(12) Patent Application Publication
(10) Pub. No.: US 2018/0183799 A1
(43) Pub. Date: Jun. 28, 2018

(54) METHOD AND SYSTEM FOR DEFENDING AGAINST MALICIOUS WEBSITE

(71) Applicants: NANNING FUGUI PRECISION INDUSTRIAL CO., LTD., Nanning (CN); HON HAI PRECISION INDUSTRY CO., LTD., New Taipei (TW)

(72) Inventor: KAI-YU YANG, New Taipei (TW)

(21) Appl. No.: 15/391,866

(22) Filed: Dec. 28, 2016

(51) Int. Cl. H04L 29/06; G06F 17/30

(52) U.S. Cl. CPC H04L 63/101; H04L 63/1416; H04L 63/1433; H04L 63/168; G06F 17/30498; G06F 17/30864; H04L 63/1425

(57) ABSTRACT

A system for defending against malicious website includes an intelligent module and a deploying module. The intelligent module collects and stores information as to malicious website from third-party trusted websites. The malicious website is rated for risk and a malicious website having a high risk is preset as a dangerous website, and a deploying signal is sent after the preset dangerous website is set. The deploying module adds the dangerous website information preset dangerous website to a flow table and deploys the flow table to a plurality of OpenFlow (OF) switch. An OF switch can detect whether a browsing website to be opened by a user is recorded in the flow table, and if so, the OF switch blocks the browsing of such website. A method for defending against malicious website is also disclosed.

### FIELD

The subject matter herein generally relates to method and system for defending against malicious websites.

### BACKGROUND

Malicious websites may have viruses. When users visit the malicious website, the malicious virus tampers with configuration information of an operation system and application programs in a computer of the user to disable or pervert the computer from working properly.

### BRIEF DESCRIPTION OF THE DRAWINGS

Implementations of the present technology will now be described, by way of example only, with reference to the attached figures.

FIG. 1 is a block diagram of a system for defending against malicious website.

FIGS. 2-3 are flowcharts of a method for defending against malicious websites according to an embodiment.

FIG. 4 is a flowchart of the method for defending against malicious websites according to another embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

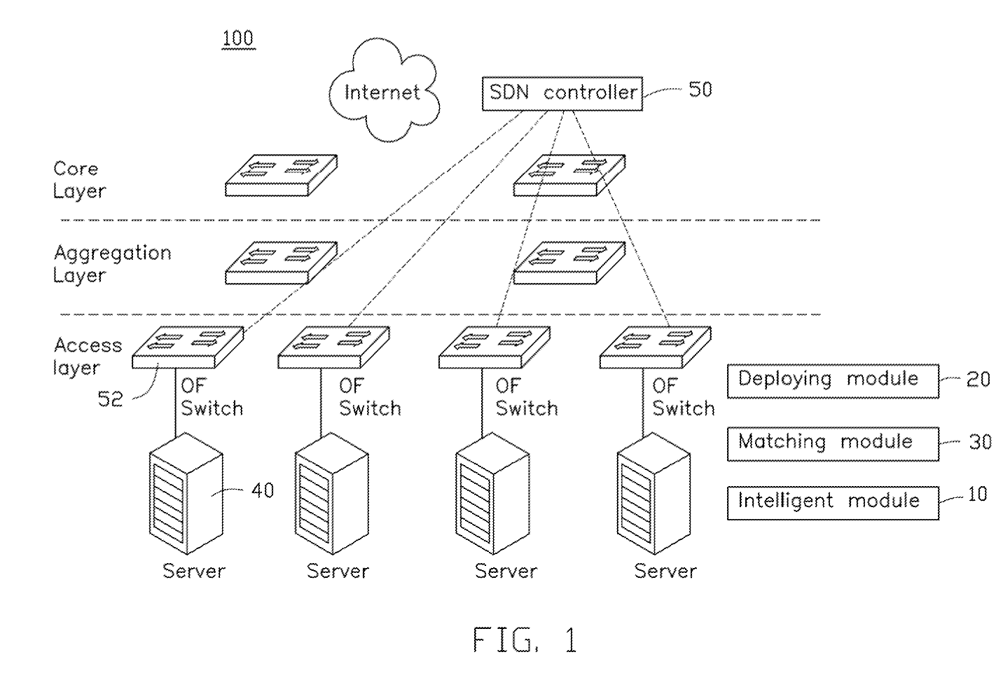

FIG. 1 illustrates a system for defending against malicious website (system 100). The system defending against malicious website 100 includes an intelligent module 10, a deploying module 20, and a matching module 30. The intelligent module 10, the deploying module 20, and the matching module 30 are set in an Access Layer of a server network (servers 40). The access layer includes a number of OpenFlow (OF) switches 52 and a number of servers 40 connected to the OF switches in an one to one manner. The OF switches 52 are controlled by a software defined network controller (SDN controller) 50.

The intelligent module 10 regularly collects malicious website information from third-party trusted websites and stores information of the malicious website in a local database. The third-party trusted website includes GOOGLE website.

The intelligent module 10 further rates the malicious website based on level of risk and sets the malicious website having a high risk as a preset dangerous website. After the preset dangerous website is set, the intelligent module 10 sends a deploying signal to the deploying module 20. In an embodiment, finance malicious websites are set as preset dangerous websites.

According to the deploying signal, the deploying module 20 queries information of the preset dangerous website. The information of the preset dangerous website includes IP address. According to the deploying signal, the deploying module 20 further joins the information of the preset dangerous website to a flow table in the server 40 and deploys the flow table to the OF switch 52 through the SDN controller 50.

The OF switch 52 detects whether a browsing website to be opened by the user is recorded in the flow table. When the browsing website is recorded in the flow table, the browsing website is blocked at the Access Layer. When the browsing website is not recorded in the flow table, the OF switch 52 transmits a DSN (Domain Name System) Query package to the matching module 30. According to the DSN Query package, the matching module 30 queries the information of the malicious website in the intelligent module 10 and determines whether the browsing website is a malicious website. When the browsing website is a malicious website, the matching module 30 transmits a malicious website signal to the deploying module 20. According to the malicious website signal, the deploying module 20 queries information of the malicious website in the intelligent module 20. The information of the malicious website includes IP address.

According to the malicious website signal, the deploying module 20 further joins the browsing website in the flow table to update the flow table and deploys the new flow table to the OF switch 52 through the SDN controller. The OF switch 52 stores the new flow table and blocks browsing of such website.

According to OpenFlow protocol, the OF switch 52 regularly transmits malicious website data to the DSN controller 50. The malicious website data includes at least one blocked website and number of times blocked for the at least one blocked website. The intelligent module 10 regularly queries the malicious website data of each OF switch 52 through the deploying module 20 to gather data as all malicious websites of the OF switches 52. The intelligent module 10 further provides an interface to set a preset available space of the flow table. The available space of the flow table can be set according to a use's requirement. The intelligent module 10 further determines whether a remaining space of the flow table is less than the preset available space. When there is information of a new malicious website to be joined to the flow table and the remaining space of the flow table is more than or equivalent to the preset available space, the deploying module 20 joins the information of the new malicious website to the flow table. When there is information of a new malicious website to be joined to the flow table and the remaining space of the flow table is less than the preset available space, the deploying module 20 replaces information in the flow table related to a malicious website having the least number of times blocked with information relating to a new malicious website.

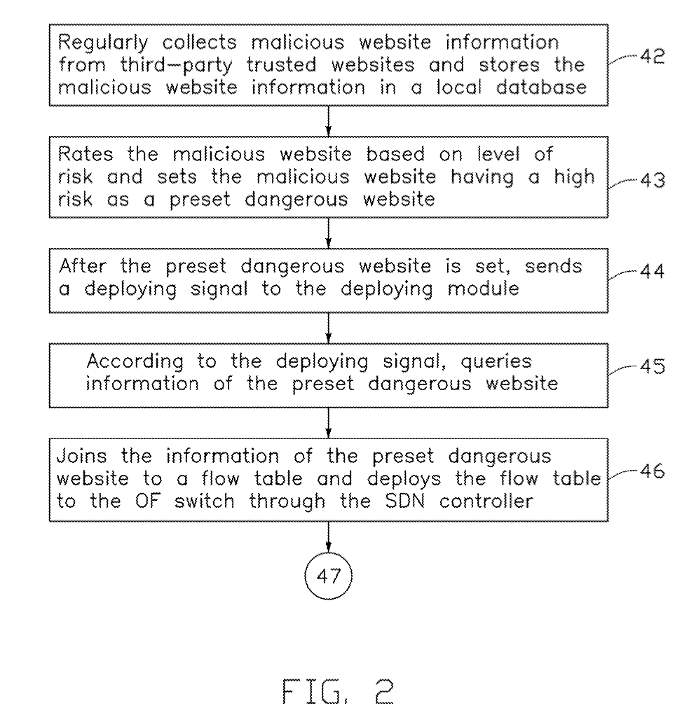

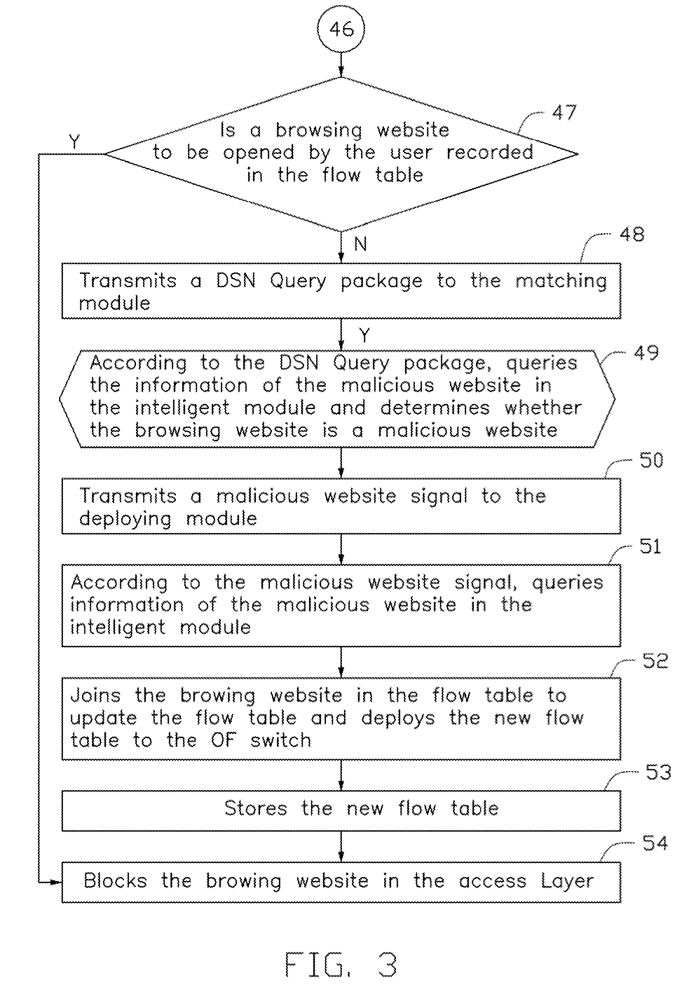

FIGS. 2-3 illustrate a method for defending against malicious website according to an embodiment. The order of blocks in FIG. 2 is illustrative only and the order of the blocks can change. Additional blocks can be added or fewer blocks may be utilized without departing from this disclosure. The exemplary method begins at block 42.

At block 42, the intelligent module 10 regularly collects malicious website information from third-party trusted websites and stores the malicious website information in a local database. The third-party trusted website includes GOOGLE website.

At block 43, the intelligent module 10 rates the malicious website based on level of risk and sets the malicious website having a high risk as a preset dangerous website.

At block 44, after the preset dangerous website is set, the intelligent module 10 sends a deploying signal to the deploying module 20.

At block 45, according to the deploying signal, the deploying module 20 queries information of the preset dangerous website. The information of the preset dangerous website includes IP address.

At block 46, the deploying module 20 joins the information of the preset dangerous website to a flow table and deploys the flow table to the OF switch 52 through the SDN controller 50.

At block 47, the OF switch 52 detects whether a browsing website to be opened by the user is recorded in the flow table. If the browsing website is recorded in the flow table, the procedure goes to block 54, otherwise the procedure goes to block 48.

At block 48, the OF switch 52 transmits a DSN Query package to the matching module 30.

At block 49, According to the DSN Query package, the matching module 30 queries the information of the malicious website in the intelligent module 20 and determines whether the browsing website is a malicious website. If the browsing website is a malicious website, the procedure goes to block 50, otherwise the procedure ends.

At block 50, the matching module 30 transmits a malicious website signal to the deploying module 20.

At block 51, according to the malicious website signal, the deploying module 20 queries information of the malicious web site in the intelligent module 20. The information of the malicious website includes IP address.

At block 52, the deploying module 20 joins the browsing website in the flow table to update the flow table and deploys the new flow table to the OF switch 52 through the SDN controller 50.

At block 53, the OF switch 52 stores the new flow table.

At block 54, the OF switch 52 blocks the browing website in the access Layer.

According to OpenFlow protocol, the OF switch 52 regularly transmits malicious website data to the DSN controller 50. The malicious website data includes at least one blocked website and number of times blocked for the at least one blocked website. The intelligent module 10 regularly queries the malicious website data of each OF switch 52 through the deploying module 20 to update all of the malicious website of the OF switches 52.

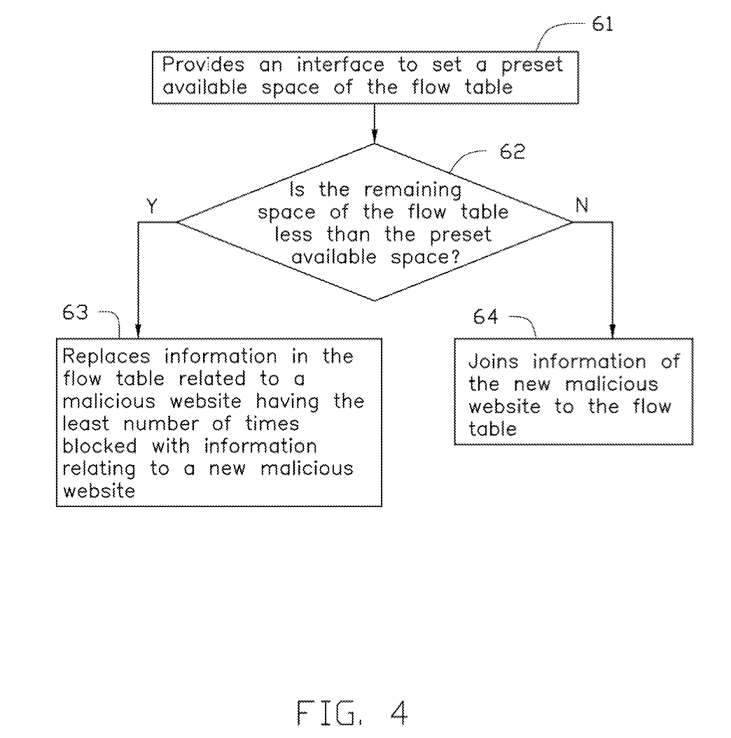

FIG. 4 illustrates a method for defending against malicious website according to another embodiment. In addition to above blocks in FIG. 2, the method further includes following blocks 61-64.

At block 61, the intelligent module 10 provides an interface to set a preset available space of the flow table. The available space of the flow table can be set according to a use's requirement.

At block 62, the intelligent module 10 determines whether the remaining space of the flow table is less than the preset available space. If the remaining space of the flow table is less than the preset available space, the procedure goes to block 63, otherwise goes to block 64.

At block 63, the deploying module 20 replaces information in the flow table related to a malicious website having the least number of times blocked with information relating to a new malicious website.

At block 64, the deploying module 20 joins information of the new malicious website to the flow table.

The embodiments shown and described above are only examples. Even though numerous dataistic and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A method for defending against malicious website, comprising:
regularly collecting malicious website information from third-party trusted websites and storing the malicious website information;
rating the malicious website based on level of risk and setting the malicious website having a high risk as a preset dangerous website;
sending a deploying signal after the preset dangerous website is set;
according to the deploying signal, joining the information of the preset dangerous website to a flow table and deploying the flow table to a plurality of OpenFlow (OF) switches;
detecting whether a browsing website to be opened is recorded in the flow table; and
when the browsing website is recorded in the flow table, blocking browsing of such website at an Access Layer of a server network.

2. The method as claimed in claim 1, further comprising:
when the browsing website is not recorded in the flow table,
querying the information of the malicious website and determining whether the browsing website is a malicious website.

3. The method as claimed in claim 2, further comprising:
when the browsing website is a malicious website, querying information of the malicious website; and
joining the browsing website in the flow table to update the flow table and deploying the new flow table to the OF switch.

4. The method as claimed in claim 1, further comprising:
regularly transmitting malicious website data by each OF switch, the malicious website data comprises at least one blocked website and number of times blocked for the at least one blocked website; and
regularly querying the malicious website data of each OF switch.

5. The method as claimed in claim 4, further comprising:
providing an interface to set a preset available space of the flow table;
determining whether a remaining space of the flow table is less than the preset available space; and
when the remaining space of the flow table is less than the preset available space, replacing information in the flow table related to a malicious website having the least number of times blocked with information relating to a new malicious website.

6. The method as claimed in claim 5, further comprising:
when the remaining space of the flow table is more than or equivalent to the preset available space, joining information of the new malicious website to the flow table.

7. The method as claimed in claim 1, wherein the third-party trusted website comprises GOOGLE website.

8. A system for defending against malicious website, comprising:
an intelligent module, configured to regularly collect malicious website information from third-party trusted websites and storing the malicious website information, rate the malicious website based on level of risk and setting the malicious website having a high risk as a preset dangerous website, and send a deploying signal after the preset dangerous website is set; and
a deploying module, configured to, according to the deploying signal, join the information of the preset dangerous website to a flow table and deploy the flow table to a plurality of OpenFlow (OF) switch;
wherein the OF switch detects whether a browsing website to be opened is recorded in the flow table, and when the browsing website is recorded in the flow table, the OF switch blocks browsing of such website at an access layer of a server network.

9. The system as claimed in claim 8, wherein the system further comprises a matching module, when the browsing website is not recorded in the flow table, the OF switch transmits a DSN Query package to the matching module, according to the DSN Query package, the matching module queries the information of the malicious website and determines whether the browsing website is a malicious website.

10. The system as claimed in claim 9, wherein when the browsing website is a malicious website, the matching module transmits a malicious website signal to the deploying module, according to the malicious website signal, the deploying module queries information of the malicious website and joins the browsing website in the flow table to update the flow table, and deploys the new flow table to the OF switch.

11. The system as claimed in claim 8, wherein the OF switch regularly transmits malicious website data, the malicious website data comprises at least one blocked website and number of times blocked for the at least one blocked website, the intelligent module regularly queries the malicious website data of each OF switch.

12. The system as claimed in claim 11, wherein intelligent module further provides an interface to set a preset available space of the flow table and determines whether a remaining space of the flow table is less than the preset available space, when the remaining space of the flow table is less than the preset available space, the deploying module replaces information in the flow table related to a malicious website having the least number of times blocked with information relating to a new malicious website.

13. The system as claimed in claim 12, wherein when the remaining space of the flow table is more than or equivalent to the preset available space, the deploying module joins information of a new malicious website to the flow table.

14. The system as claimed in claim 9, wherein the third-party trusted website comprises GOOGLE website.
